(19) United States
(12) Patent Application Publication
(10) Pub. No.: US 2026/0332310 A1
(43) Pub. Date: Oct. 22, 2026

(54) TECHNIQUES FOR FEEDBACK MESSAGE PAYLOAD SIZE CORRECTION

(71) Applicant: QUALCOMM Incorporated, San Diego, CA (US)

(72) Inventors: Wei YANG, San Diego, CA (US); Mostafa KHOSHNEVISAN, San Diego, CA (US); Jing JIANG, San Diego, CA (US); Gabi SARKIS, San Diego, CA (US)

(21) Appl. No.: 19/181,231

(22) Filed: Apr. 16, 2025

(51) Int. Cl. H04L 1/1812; H04L 1/1867

(52) U.S. Cl. CPC H04L 1/1812; H04L 1/1867

(57) ABSTRACT

This disclosure provides methods, components, devices and systems for techniques for feedback message payload size correction. For example, techniques described herein may enable cyclic redundancy check (CRC) computation using a modified set of bits to differentiate between a CRC computed based on a relatively shorter hybrid automatic feedback request (HARQ) message and a CRC computed based on a relatively longer HARQ message. For example, a user equipment (UE) and a network entity may compute the CRC based on appending a quantity of ones to the payload prior to computing the CRC, by reversing an order of information bits of the payload prior to computing the CRC, or by using HARQ size-specific CRC computation function to compute the CRC such that a CRC function for a relatively larger HARQ message may be different from a CRC function for a relatively shorter HARQ message.

### TECHNICAL FIELD

This disclosure relates generally to wireless communication, and more specifically to systems, devices, methods, and techniques associated with techniques for feedback message payload size correction.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a network entity is described. The method may include outputting a downlink control information message scheduling one or more transmissions, outputting the one or more transmissions, obtaining a hybrid automatic feedback request (HARQ) feedback message, decoding the HARQ feedback message according to a decoding scheme to obtain a first set of bits indicative of a first cyclic redundancy check (CRC) and a second set of bits indicative of a payload, where the payload includes HARQ feedback information for the one or more transmissions, and determining the HARQ feedback information for the one or more transmissions in accordance with a comparison of the first CRC with a second CRC that is computed based on appending a quantity of ones to the second set of bits.

A network entity for wireless communications is described. The network entity may include a processing system that includes processor circuitry and memory circuitry that stores code. The processing system may be configured to cause the network entity to output a downlink control information message scheduling one or more transmissions, output the one or more transmissions, obtain an HARQ feedback message, decode the HARQ feedback message according to a decoding scheme to obtain a first set of bits indicative of a first CRC and a second set of bits indicative of a payload, where the payload includes HARQ feedback information for the one or more transmissions, and determine the HARQ feedback information for the one or more transmissions in accordance with a comparison of the first CRC with a second CRC that is computed based on appending a quantity of ones to the second set of bits.

Another network entity for wireless communications is described. The network entity may include means for outputting a downlink control information message scheduling one or more transmissions, means for outputting the one or more transmissions, means for obtaining an HARQ feedback message, means for decoding the HARQ feedback message according to a decoding scheme to obtain a first set of bits indicative of a first CRC and a second set of bits indicative of a payload, where the payload includes HARQ feedback information for the one or more transmissions, and means for determining the HARQ feedback information for the one or more transmissions in accordance with a comparison of the first CRC with a second CRC that is computed based on appending a quantity of ones to the second set of bits.

A non-transitory computer-readable medium storing code for wireless communications is described. The code may include instructions executable by one or more processors to output a downlink control information message scheduling one or more transmissions, output the one or more transmissions, obtain an HARQ feedback message, decode the HARQ feedback message according to a decoding scheme to obtain a first set of bits indicative of a first CRC and a second set of bits indicative of a payload, where the payload includes HARQ feedback information for the one or more transmissions, and determine the HARQ feedback information for the one or more transmissions in accordance with a comparison of the first CRC with a second CRC that is computed based on appending a quantity of ones to the second set of bits.

In some examples of the method, network entities, and non-transitory computer-readable medium described herein, determining the HARQ feedback information may include operations, features, means, or instructions for determining that a UE did not receive the one or more transmissions based on the first CRC being different from the second CRC and outputting one or more retransmissions of the one or more transmissions.

A method for wireless communications by a UE is described. The method may include monitoring for one or more transmissions from a network entity, computing a first set of bits indicative of a first CRC based on appending a quantity of ones to a second set of bits indicative of a payload, where the payload includes HARQ feedback information for the one or more transmissions, encoding the second set of bits according to an encoding scheme, and transmitting the first set of bits and the encoded second set of bits.

A UE for wireless communications is described. The UE may include a processing system that includes processor circuitry and memory circuitry that stores code. The processing system may be configured to cause the UE to monitor for one or more transmissions from a network entity, compute a first set of bits indicative of a first CRC based on appending a quantity of ones to a second set of bits indicative of a payload, where the payload includes HARQ feedback information for the one or more transmissions, encode the second set of bits according to an encoding scheme, and transmit the first set of bits and the encoded second set of bits.

Another UE for wireless communications is described. The UE may include means for monitoring for one or more transmissions from a network entity, means for computing a first set of bits indicative of a first CRC based on appending a quantity of ones to a second set of bits indicative of a payload, where the payload includes HARQ feedback information for the one or more transmissions, means for encoding the second set of bits according to an encoding scheme, and means for transmitting the first set of bits and the encoded second set of bits.

A non-transitory computer-readable medium storing code for wireless communications is described. The code may include instructions executable by one or more processors to monitor for one or more transmissions from a network entity, compute a first set of bits indicative of a first CRC based on appending a quantity of ones to a second set of bits indicative of a payload, where the payload includes HARQ feedback information for the one or more transmissions, encode the second set of bits according to an encoding scheme, and transmit the first set of bits and the encoded second set of bits.

A method for wireless communications by a network entity is described. The method may include outputting a downlink control information message scheduling one or more transmissions, outputting the one or more transmissions, obtaining an HARQ feedback message, decoding the HARQ feedback message according to an encoding scheme to obtain a first set of bits indicative of a first CRC and a second set of bits indicative of a payload, where the payload includes HARQ feedback information for the one or more transmissions, and determining HARQ feedback information for the one or more transmissions based on a comparison of the first CRC and a second CRC determined from the payload and reversing an order of the second set of bits.

A network entity for wireless communications is described. The network entity may include a processing system that includes processor circuitry and memory circuitry that stores code. The processing system may be configured to cause the network entity to output a downlink control information message scheduling one or more transmissions, output the one or more transmissions, obtain an HARQ feedback message, decode the HARQ feedback message according to an encoding scheme to obtain a first set of bits indicative of a first CRC and a second set of bits indicative of a payload, where the payload includes HARQ feedback information for the one or more transmissions, and determine HARQ feedback information for the one or more transmissions based on a comparison of the first CRC and a second CRC determined from the payload and reversing an order of the second set of bits.

Another network entity for wireless communications is described. The network entity may include means for outputting a downlink control information message scheduling one or more transmissions, means for outputting the one or more transmissions, means for obtaining an HARQ feedback message, means for decoding the HARQ feedback message according to an encoding scheme to obtain a first set of bits indicative of a first CRC and a second set of bits indicative of a payload, where the payload includes HARQ feedback information for the one or more transmissions, and means for determining HARQ feedback information for the one or more transmissions based on a comparison of the first CRC and a second CRC determined from the payload and reversing an order of the second set of bits.

A non-transitory computer-readable medium storing code for wireless communications is described. The code may include instructions executable by one or more processors to output a downlink control information message scheduling one or more transmissions, output the one or more transmissions, obtain an HARQ feedback message, decode the HARQ feedback message according to an encoding scheme to obtain a first set of bits indicative of a first CRC and a second set of bits indicative of a payload, where the payload includes HARQ feedback information for the one or more transmissions, and determine HARQ feedback information for the one or more transmissions based on a comparison of the first CRC and a second CRC determined from the payload and reversing an order of the second set of bits.

Some examples of the method, network entities, and non-transitory computer-readable medium described herein may further include operations, features, means, or instructions for determining the HARQ feedback information in accordance with the first CRC being the same as the second CRC.

A method for wireless communications by a UE is described. The method may include monitoring for one or more transmissions, computing a first set of bits indicative of a first CRC based on reversing an order of a second set of bits indicative of a payload, where the payload includes HARQ feedback information for the one or more transmissions from a network entity, encoding a HARQ feedback message including the first set of bits and the reversed second set of bits according to an encoding scheme, and transmitting the HARQ feedback message.

A UE for wireless communications is described. The UE may include a processing system that includes processor circuitry and memory circuitry that stores code. The processing system may be configured to cause the UE to monitor for one or more transmissions, compute a first set of bits indicative of a first CRC based on reversing an order of a second set of bits indicative of a payload, where the payload includes HARQ feedback information for the one or more transmissions from a network entity, encode a HARQ feedback message including the first set of bits and the reversed second set of bits according to an encoding scheme, and transmit the HARQ feedback message.

Another UE for wireless communications is described. The UE may include means for monitoring for one or more transmissions, means for computing a first set of bits indicative of a first CRC based on reversing an order of a second set of bits indicative of a payload, where the payload includes HARQ feedback information for the one or more transmissions from a network entity, means for encoding a HARQ feedback message including the first set of bits and the reversed second set of bits according to an encoding scheme, and means for transmitting the HARQ feedback message.

A non-transitory computer-readable medium storing code for wireless communications is described. The code may include instructions executable by one or more processors to monitor for one or more transmissions, compute a first set of bits indicative of a first CRC based on reversing an order of a second set of bits indicative of a payload, where the payload includes HARQ feedback information for the one or more transmissions from a network entity, encode a HARQ feedback message including the first set of bits and the reversed second set of bits according to an encoding scheme, and transmit the HARQ feedback message.

A method for wireless communications by a network entity is described. The method may include outputting a downlink control information message scheduling one or more transmissions, outputting the one or more transmissions, obtaining an HARQ feedback message including a first set of bits indicative of a first CRC and a second set of bits indicative of a payload, where the payload includes HARQ feedback information for the one or more transmissions, computing a second CRC based on decoding the HARQ feedback message according to an encoding scheme and inputting the second set of bits into a first CRC computation function associated with a first size of the HARQ feedback message, and determining HARQ feedback information for the one or more transmissions in accordance with a comparison of the first CRC and the second CRC.

A network entity for wireless communications is described. The network entity may include a processing system that includes processor circuitry and memory circuitry that stores code. The processing system may be configured to cause the network entity to output a downlink control information message scheduling one or more transmissions, output the one or more transmissions, obtain an HARQ feedback message including a first set of bits indicative of a first CRC and a second set of bits indicative of a payload, where the payload includes HARQ feedback information for the one or more transmissions, compute a second CRC based on decoding the HARQ feedback message according to an encoding scheme and inputting the second set of bits into a first CRC computation function associated with a first size of the HARQ feedback message, and determine HARQ feedback information for the one or more transmissions in accordance with a comparison of the first CRC and the second CRC.

Another network entity for wireless communications is described. The network entity may include means for outputting a downlink control information message scheduling one or more transmissions, means for outputting the one or more transmissions, means for obtaining an HARQ feedback message including a first set of bits indicative of a first CRC and a second set of bits indicative of a payload, where the payload includes HARQ feedback information for the one or more transmissions, means for computing a second CRC based on decoding the HARQ feedback message according to an encoding scheme and inputting the second set of bits into a first CRC computation function associated with a first size of the HARQ feedback message, and means for determining HARQ feedback information for the one or more transmissions in accordance with a comparison of the first CRC and the second CRC.

A non-transitory computer-readable medium storing code for wireless communications is described. The code may include instructions executable by one or more processors to output a downlink control information message scheduling one or more transmissions, output the one or more transmissions, obtain an HARQ feedback message including a first set of bits indicative of a first CRC and a second set of bits indicative of a payload, where the payload includes HARQ feedback information for the one or more transmissions, compute a second CRC based on decoding the HARQ feedback message according to an encoding scheme and inputting the second set of bits into a first CRC computation function associated with a first size of the HARQ feedback message, and determine HARQ feedback information for the one or more transmissions in accordance with a comparison of the first CRC and the second CRC.

Some examples of the method, network entities, and non-transitory computer-readable medium described herein may further include operations, features, means, or instructions for computing a third CRC based on inputting the second set of bits into a second CRC computation function associated with a second size of the HARQ feedback message, where determining the HARQ feedback information includes determining that a UE did not receive a downlink control information message indicating a size of the HARQ feedback message in accordance with the third CRC being different from the first CRC, where computing the second CRC may be based on the third CRC being different from the first CRC.

A method for wireless communications by a UE is described. The method may include monitoring for one or more transmissions from a network entity, computing a first set of bits indicative of a first CRC based at least in part on inputting a second set of bits indicative of a payload into a first CRC computation function associated with a size of an HARQ feedback message, where the payload includes HARQ feedback information for the one or more transmissions, encoding the HARQ feedback message according to an encoding scheme, and transmitting the HARQ feedback message including the first set of bits and the second set of bits.

A UE for wireless communications is described. The UE may include a processing system that includes processor circuitry and memory circuitry that stores code. The processing system may be configured to cause the UE to monitor for one or more transmissions from a network entity, compute a first set of bits indicative of a first CRC based at least in part on inputting a second set of bits indicative of a payload into a first CRC computation function associated with a size of an HARQ feedback message, where the payload includes HARQ feedback information for the one or more transmissions, encode the HARQ feedback message according to an encoding scheme, and transmit the HARQ feedback message including the first set of bits and the second set of bits.

Another UE for wireless communications is described. The UE may include means for monitoring for one or more transmissions from a network entity, means for computing a first set of bits indicative of a first CRC based at least in part on inputting a second set of bits indicative of a payload into a first CRC computation function associated with a size of an HARQ feedback message, where the payload includes HARQ feedback information for the one or more transmissions, means for encoding the HARQ feedback message according to an encoding scheme, and means for transmitting the HARQ feedback message including the first set of bits and the second set of bits.

A non-transitory computer-readable medium storing code for wireless communications is described. The code may include instructions executable by one or more processors to monitor for one or more transmissions from a network entity, compute a first set of bits indicative of a first CRC based at least in part on inputting a second set of bits indicative of a payload into a first CRC computation function associated with a size of an HARQ feedback message, where the payload includes HARQ feedback information for the one or more transmissions, encode the HARQ feedback message according to an encoding scheme, and transmit the HARQ feedback message including the first set of bits and the second set of bits.

### BRIEF DESCRIPTION OF THE DRAWINGS

FIG. 1 shows an example of a wireless communication system.

FIG. 2 shows an example of a signaling configuration that supports techniques for feedback message payload size correction.

FIG. 3 shows an example of a process flow that supports techniques for feedback message payload size correction.

FIG. 4 shows a block diagram of a processing system that supports techniques for feedback message payload size correction.

FIG. 5 shows a diagram of a system including a device that supports techniques for feedback message payload size correction.

FIG. 6 shows a block diagram of a processing system that supports techniques for feedback message payload size correction.

FIG. 7 shows a diagram of a system including a device that supports techniques for feedback message payload size correction.

FIGS. 8 through 13 show flowcharts illustrating methods that support techniques for feedback message payload size correction.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communications systems, a user equipment (UE) may transmit a hybrid automatic repeat request (HARQ) feedback message (e.g., a HARQ-ACK message) indicating whether the UE received one or more messages (e.g., code blocks (CBs)) from a network entity. The UE may compute a parity value (e.g., a cyclic redundancy check (CRC)) based on inputting one or more bits of the HARQ feedback message into a function. The UE may encode the HARQ message using polar coding techniques in which the UE may append a quantity of frozen bits (e.g., zeroes) to the message prior to transmission.

In some examples, however, the UE may not receive or successfully decode a control message (e.g., a downlink control information (DCI) message) indicating a size of the HARQ feedback message. In such examples, the UE may transmit a HARQ message with a relatively smaller size than a size expected by the network entity, which may be associated with a same CRC as a relatively longer HARQ message including one or more zeros prior to a matching set of information bits. For example, a message with a payload of [a1, a2, . . . aN] may result in a same CRC as a message with a payload of [0, 0, 0, a1, a2, . . . aN]. The network entity may accordingly interpret one or more of the frozen bits (e.g., zeroes) as information bits, which may result in the network entity incorrectly decoding the HARQ message.

Aspects of the subject matter described in this disclosure relate to techniques for CRC computation using a modified set of bits to differentiate between a CRC computed based on a relatively shorter HARQ message and a CRC computed based on a relatively longer HARQ message. For example, the UE and the network entity may compute the CRC based on appending a quantity of ones to the payload prior to computing the CRC. Additionally, or alternatively, the UE and the network entity may reverse an order of information bits of the payload prior to computing the CRC. Additionally, or alternatively, the UE and the network entity may use HARQ size-specific CRC computation function to compute the CRC such that a CRC function for a relatively larger HARQ message may be different from a CRC function for a relatively shorter HARQ message.

Particular aspects of the subject matter described in this disclosure can be implemented to realize one or more of the following potential advantages. In some examples, by enabling differentiation between CRCs computed using differently sized HARQ payloads, the described techniques can be used to improve coordination between device by enabling a network entity to more accurately determine HARQ feedback from a UE. For example, by computing CRCs using a set of ones appended to the payload, a reversed payload, or size-specific CRC computation functions, the network entity may determine whether a UE received a DCI indicating a HARQ size. The network entity may accordingly retransmit one or more transmissions to the UE, which may result in improved coordination and improved reliability in the wireless communications system.

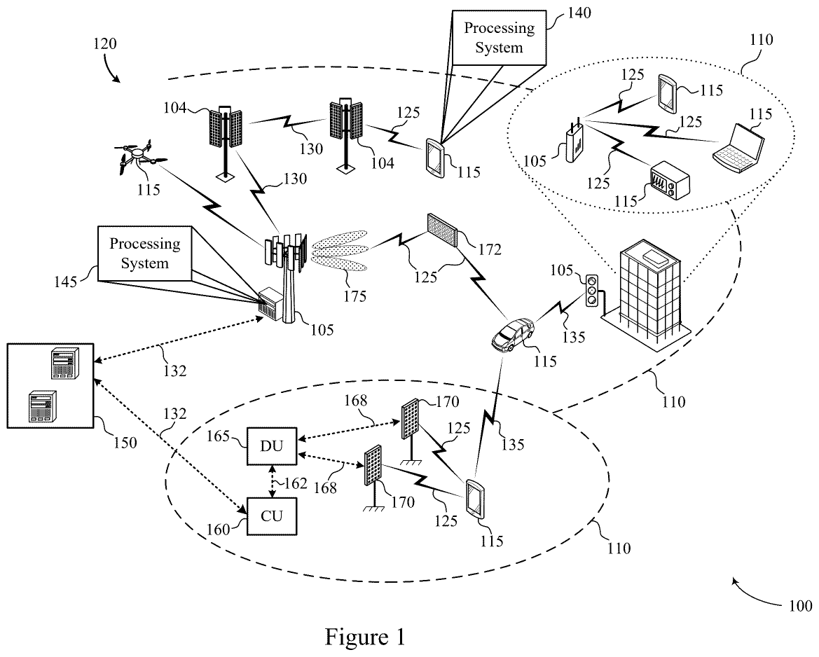

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

To transmit information, a transmitting device (e.g., a UE 115, a network entity 105) may encode a set of information bits via an encoder. An encoder may have a finite input bus width or input bits of a single input vector may become available at different times. For example, an input vector may include information bits, parity bits, check bits, etc., where some or all information bits may be generated by or received from different sources. Parity bits may be used in parity check (PC), or cyclic redundancy check (CRC) techniques. Construction of an input vector may depend on information bit location/distribution amongst the channel instances of the encoder. The input vector may be, for example, a physical channel message (e.g., control channel message) or a data or shared channel message (e.g., a data packet). The encoder may generate different redundancy versions (RVs), which may include different combinations of encoded bits (e.g., systematic bits, redundancy bits).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)), and may support retransmissions of different RVs. HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

System performance of transmission of information bits in low-latency environments may be determined by factors such as overhead, coding gain, transmission pipelining, and decoding delay. Some processing techniques may emphasize improving transmission pipelining and decoding delay at the expense of higher overhead and lower coding gain. Generally, use of a larger code length (e.g., larger codeword) provides higher coding gain. However, a larger code length result in a larger decoding delay and overall system latency. In contrast, smaller code length reduces latency or decoding delay, but may result in an increase in overhead or lower coding gain.

Devices of the wireless communication system 100 may be configured to support one or more aspects of the described techniques for feedback message payload size correction. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may enable the UE 115 and the network entity 105 to differentiate between a CRC computed based on a relatively shorter HARQ message and a CRC computed based on a relatively longer HARQ message.

For example, the UE 115 and the network entity 105 may compute the CRC based on appending a quantity of ones to the payload prior to computing the CRC. Additionally, or alternatively, the UE 115 and the network entity 105 may reverse an order of information bits of the payload prior to computing the CRC. Additionally, or alternatively, the UE 115 and the network entity 105 may use a HARQ size-specific CRC computation function to compute the CRC such that a CRC function for a relatively larger HARQ message may be different from a CRC function for a relatively shorter HARQ message. Accordingly, the network entity 105 may not incorrectly decode HARQ messages based on a HARQ size mismatch, which may increase reliability of the wireless communications system by improving coordination between devices.

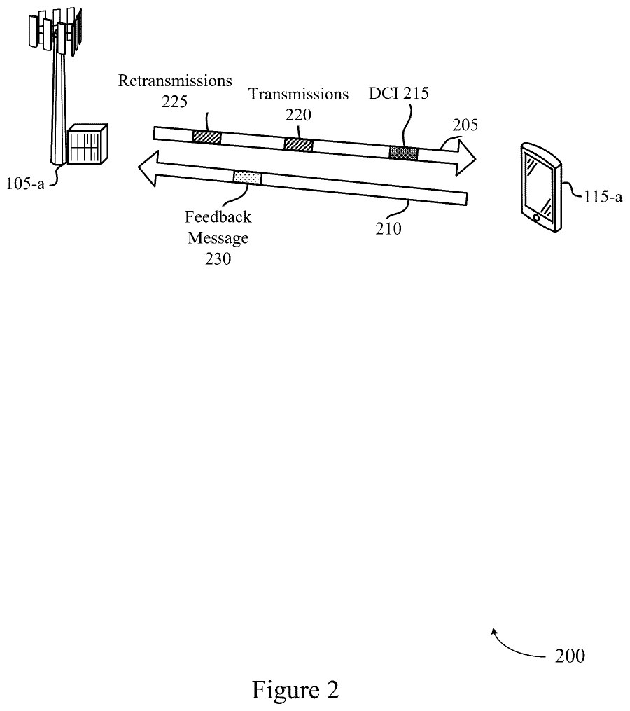

FIG. 2 shows an example of a signaling configuration 200 that supports techniques for feedback message payload size correction. The signaling configuration 200 may implement or may be implemented by aspects of the wireless communication system 100. For example, the signaling configuration 200 may be implemented by a UE 115 (e.g., a UE 115-a) or a network entity 105 (e.g., a network entity 105-a), which may be examples of the corresponding devices as described with reference to FIG. 1.

In some examples of the signaling configuration 200, a network entity 105-a may transmit control signaling (e.g., DCI 215, a system information block (SIB), an RRC message, a medium access control-control element (MAC-CE)) and one or more transmissions 220 (e.g., data messages, physical downlink shared channel (PDSCH) transmissions, code blocks) to a UE 115-a via a downlink channel 205. In some examples, the UE 115-a may transmit, via an uplink channel 210, a feedback message 230 (e.g., a message including HARQ feedback information) to the network entity 105-a that indicates whether the UE 115-a received one or more transmissions 220. For example, the feedback message 230 may include ACK information for one or more transmissions 220 that were successfully received and decoded by the UE 115-a and NACK information for one or more transmissions 220 that were not successfully received and decoded by the UE 115-a. The network entity 105-a may accordingly transmit one or more retransmissions 225 of the transmissions 220 that were not successfully received.

In some examples, to increase a likelihood that the network entity 105-a may successfully receive and decode the feedback message 230 (e.g., an uplink control information (UCI) message), the UE 115-a may encode the feedback message 230 using a polar encoding scheme. For example, the UE 115-a may input a set of bits (e.g., a set of information bits and a set of frozen bits with a set value) into a corresponding set of channels. The channels may output an encoded set of bits that include information about the input set of bits (e.g., via one or more exclusive-OR (XOR) operations performed on the set of channels). The encoded set of bits may include relatively more information related to some channels (e.g., a first subset of channels) and relatively less information related to some other channels (e.g., a second subset of channels). Accordingly, to increase a likelihood that the network entity 105-a may successfully receive the set of information bits, the UE 115-a may input the information bits (e.g., and one or more bits related to performing integrity checks and the like, such as parity bits or a CRC) into the first subset of channels and the set of frozen bits into the second subset of channels.

In some examples, the network entity 105-a may output control signaling that indicates a size of the feedback message 230 (e.g., a Type2 dynamic HARQ-ACK code block). In such examples, if the UE 115-a misses the control signaling (e.g., a DCI 215), the network entity 105-a may not correct the size of the feedback message 230 (e.g., via a downlink assignment index (DAI)). The UE 115-a may therefore transmit a feedback message 230 that is a different size than a feedback message 230 expected by the network entity 105-a. For example, the network entity 105-a may assume a larger code block size than the UE 115-a.

In some examples, if a total payload size of the feedback message 230 is larger than or equal to a threshold size (e.g., 12 bits), the UE 115-a may append a first CRC with a length L to the payload. In some examples, the first CRC may be a set of bits used to confirm that a receiving device (e.g., the network entity 105-a) correctly decoded the payload. For example, the network entity 105-a may generate a second CRC based on a decoded payload, and may compare the second CRC with the first CRC. If the second CRC is the same as the first CRC, the network entity 105-a may assume that the payload is correctly decoded. If the second CRC is different from the first CRC, the network entity 105-a may assume that the payload is incorrectly decoded.

The UE 115-a may perform polar coding to encode the code block and CRC to generate the feedback message 230. In some examples, the UE 115-a may generate such a CRC using a CRC computation function. The CRC computation function may output a same CRC for a message with a payload of [a1, a2, . . . aN] as for a message with a payload of [0, 0, 0, a1, a2, . . . aN]. That is, one or more 0's appended to the beginning of a message may not change an output of the CRC generation function.

Accordingly, if the network entity 105-a expects a message with a relatively longer payload than the UE 115-a (e.g., due to the UE 115-a missing the control signaling indicating for the UE 115-a to use a larger HARQ payload size), the network entity may incorrectly decode the feedback message 230. For example, the network entity 105-a may assume that one or more frozen bits associated with the polar encoding (e.g., bits that were set to 0 as part of the polar encoding) are one or more first bits of the feedback message 230. As an illustrative example, if the UE 115-a outputs a payload of [a1, a2, . . . aN] and if channel conditions are relatively good such that the network entity 105-a may receive frozen bits transmitted on relatively lower quality channels, the network entity 105-a may interpret the payload as [0, 0, 0, a1, a2, . . . aN] (e.g., due to treating some of the frozen bits as unknown information bits). The network entity 105-a may generate a second CRC based on the payload of [0, 0, 0, a1, a2, . . . aN], which may be the same as a first CRC generated by the UE 115-a based on the payload of [a1, a2, . . . aN]. The network entity 105-a may therefore incorrectly determine that the payload has been successfully decoded, which may result in a NACK to ACK errors or ACK to NACK (A2N) errors that may not be resolved via lower layer signaling.

In other words, the CRC may not prevent the network entity 105-a from miscoding a code block size when polar coding is used to encode and decode the feedback message 230. For example, the network entity 105-a may interpret the frozen bits (e.g., 0's) as NACKs, and may misinterpret one or more bits of the payload as ACKs. Such NACK to ACK errors may prevent the network entity 105-a from retransmitting one or more missed transmissions 220, which may reduce a reliability of the signaling configuration 200.

In some aspects, to prevent incorrect decoding of feedback message 230 due to such a payload size mismatch, the UE 115-a and the network entity 105-a may append a quantity of bits set to a value of 1 to a beginning of a payload of the feedback message. For example, for a UCI payload of [a1, a2, . . . aN], the UE 115-a may compute the first CRC using a set of bits [1, 1, . . . 1, a1, a2, . . . aN]. In some examples, a quantity of 1's appended to the payload may be greater than or equal to a length of the first CRC. Accordingly, if the network entity 105-a interprets the one or more frozen bits as part of the payload, the network entity 105-a may generate the second CRC using a set of bits [1, 1, . . . 1, 0, 0, . . . 0, a1, a2, . . . aN], which may not result in a same CRC as the set of bits [1, 1, . . . 1, a1, a2, . . . aN]. The network entity 105-a may therefore not pass a CRC check (e.g., by comparing the first CRC with the second CRC) if there is a HARQ-ACK code block size mismatch.

In some aspects, the appended quantity of bits may include one or more values that are different from 1. For example, the UE 115-a and the network entity 105-a may append a quantity of bits to the beginning of the feedback message, and a last bit of the quantity of bits may be set of a value of 1. The remaining bits of the quantity of bits may be set according to another sequence (e.g., arbitrarily, according to a preconfigured binary sequence, based on an identifier (ID) of the UE 115-a, based on a cell ID of the network entity 105-a). As an illustrative example, for a UCI payload of [a1, a2, . . . aN], the UE 115-a may compute the first CRC using a set of bits [x1, x2, . . . xN, 1, a1, a2, . . . aN], where [x1, x2, . . . xN] is another sequence of bits. The network entity 105-a may append the bits [x1, x2, . . . xN, 1] to a beginning of a received UCI to generate the second CRC.

In such examples, the network entity 105-a may not obtain information indicated via the payload of the feedback message 230 if there is a HARQ-ACK code block size mismatch. The network entity 105-a may accordingly assume that the transmissions 220 were not received, which may result in one or more A2N events (e.g., ACK to NACK errors). The network entity 105-a may accordingly retransmit all of the transmissions 220, which may increase an overhead of the signaling configuration.

Additionally, or alternatively, in some aspects, the UE 115-a and the network entity 105-a may reverse an order of bits in a payload of the feedback message. For example, for a UCI payload of [a1, a2, . . . aN], the UE 115-a may compute the first CRC using a set of bits [aN, . . . a2, a1]. The UE 115-a may encode the reversed payload and the CRC according to a polar coding scheme as described herein. For example, the UE 115-a may append the CRC to an end of the reversed payload [aN, . . . a2, a1], and may encode the reversed payload appended with the CRC. Accordingly, if the network entity 105-a interprets the one or more frozen bits as part of the payload, the network entity 105-a may generate the second CRC using a set of bits [0, 0, . . . 0, aN, . . . a2, a1]. In such examples, the second CRC may be the same as the first CRC. Accordingly, the network entity 105-a may correctly decode bits [a1, a2, . . . aN], and may interpret the frozen bits as NACKs for one or more missed grants in the decoded payload. In other words, the frozen bits may pad the payload with one or more NACKs. Such techniques may reduce a quantity of A2N errors, and may enable the network entity 105-a to transmits retransmissions 225 of the missed grants (e.g., and one or more missed transmissions 220 indicated via the feedback message 230).

In examples in which the UE 115-a multiplexes the feedback message 230 with one or more additional UCI messages (e.g., channel state information (CSI) messages, scheduling requests (SRs)), the UE 115-a may encode the feedback message 230 and the one or more additional UCI messages with the one or more additional UCI messages located sequentially after the reversed payload of the feedback message 230. For example, for a set of bits [b1, . . . bK] of an additional UCI message, the UE 115-a may encode and transmit a set of bits [aN, . . . a2, a1, b1, . . . bK] appended with a CRC that is computed based on the set of bits [aN, . . . a2, a1, b1, . . . bK]. The UE 115-a may compute the CRC and may append the computed CRC to the end of the set of bits [aN, . . . a2, a1, b1, . . . bK], and may encode the set of bits and the appended CRC. The network entity 105-a may accordingly pad one or more zeros (e.g., frozen bits) sequentially before the reversed payload of the feedback message 230, which may not reduce a reliability of decoding the additional UCI message.

Additionally, or alternatively, in some aspects, the UE 115-a and the network entity 105-a may compute CRCs using a CRC computation function that is associated with (e.g., a function of) a size of the payload of the feedback message 230. For example, the UE 115-a and the network entity 105-a may apply a scrambling (e.g., a CRC mask) to the CRC bits that is based on the HARQ-ACK code block size, or may use a CRC polynomial (e.g., with a same CRC length) that is based on the HARQ-ACK code block size. Accordingly, the network entity 105-a may decode the feedback message 230 (e.g., using the polar coding scheme) based on a code block size that is scheduled by the network entity 105-a.

The network entity 105-a may generate a second CRC based on the code block size that is scheduled by the network entity 105-a. If the CRC passes (e.g., if the second CRC is the same as the first CRC of the feedback message 230), the network entity 105-a may assume that the feedback message 230 is successfully decoded and may determine feedback information indicated by the payload. If the CRC does not pass (e.g., if the second CRC is not the same as the first CRC of the feedback message 230), the network entity 105-a may generate a third CRC based on a different code block size (e.g., a code block size that was previously configured for the UE 115-a), and may perform an additional comparison of the first CRC with the third CRC. The network entity 105-a may determine the HARQ-ACK code block size transmitted by the UE 115-a based on whether the second CRC or the third CRC is the same as the first CRC.

In some examples, a quantity of sizes of the feedback message 230 (e.g., a quantity of HARQ-ACK code block sizes) may be variable (e.g., depending on a quantity of grants missed by the UE 115-a). Accordingly, the code block size-specific CRC scrambling or polynomial may be associated with a modulo operation of a code block size hypothesis. As an illustrative example, the UE 115-a and the network entity 105-a may be configured with two CRC masks (e.g., a first CRC mask and a second CRC mask, which may be defined according to a rule). The UE 115-a and the network entity 105-a may use the first CRC mask when the code block size is an even quantity of bits, and the second CRC mask when the code block size is an odd quantity of bits. In such an example, if the UE 115-a is configured with a code block size of 20 and the UE 115-a misses a first grant indicating a code block size of 21, the UE 115-a may transmit the feedback message 230 with the code block size of 20 with a first CRC that is scrambled using the first CRC mask. The network entity 105-a may decode the feedback message 230 assuming a code block size of 21, and may compute and scramble the second CRC using the second CRC mask. The second CRC may not pass (e.g., may be different from the first CRC). The network entity 105-a may compute and scramble a third CRC using the first CRC mask, which may be the same as the first CRC.

The network entity 105-a may accordingly determine that the code block size used by the UE 115-a is an even number. In some examples, the network entity 105-a may determine that a most recently configured code block size is relatively more likely to be the code block size used by the UE 115-a. Referring again to the previous example, the network entity 105-a may assume that the UE 115-a used a code block size of 20, and may determine that the UE 115-a missed at least one grant (e.g., a grant indicating the code block size of 21).

The described techniques may accordingly prevent the network entity 105-a from incorrectly determining that a payload of a feedback message 230 has been successfully decoded. Such techniques may enable relatively improved reliability in the signaling configuration 200 by reducing a quantity of NACK to ACK errors.

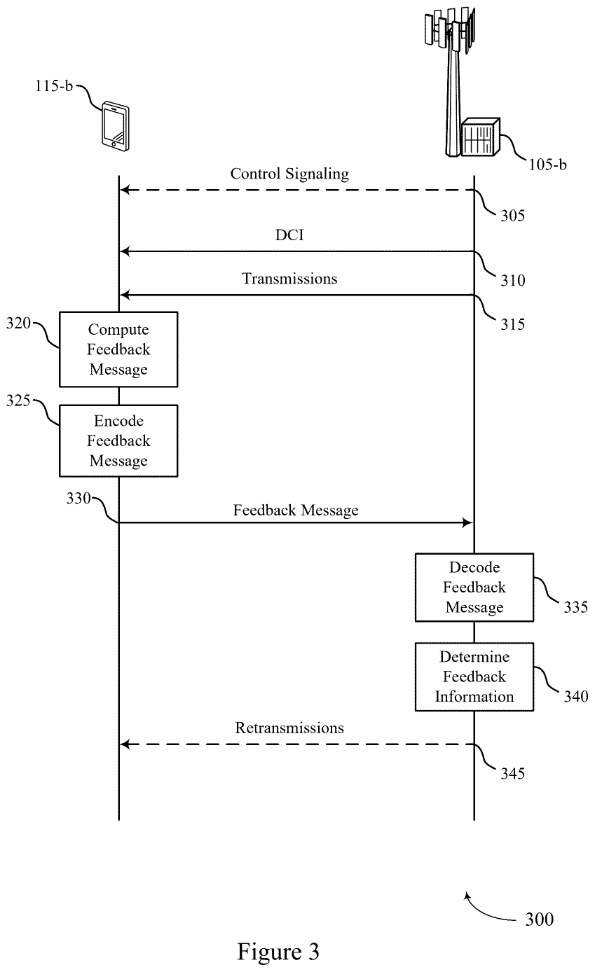

FIG. 3 shows an example of a process flow 300 that supports techniques for feedback message payload size correction. The process flow 300 may implement or may be implemented by aspects of the wireless communication system 100 or the signaling configuration 200. For example, the process flow 300 may be implemented by a UE 115 (e.g., a UE 115-b) or a network entity 105 (e.g., a network entity 105-b), which may be examples of the corresponding devices as described with reference to FIG. 1.

In the following description of the process flow 300, the operations between the UE 115-b and the network entity 105-b may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

In some examples, at 305, the network entity 105-b may output, to the UE 115-b, control signaling indicating a size of a HARQ feedback message. For example, the control signaling may indicate for the UE 115-b to switch from using a first feedback message size (e.g., a first quantity of bits for feedback information) to a second feedback message size (e.g., a second quantity of bits for feedback information).

At 310, the network entity 105-b may output, to the UE 115-b, a DCI message that schedules one or more transmissions (e.g., downlink transmission, physical downlink shared channel (PDSCH) messages, code blocks) from the network entity 105-b. At 315, the network entity 105-b may output (e.g., and the UE 115-b may monitor for) the one or more transmissions.

At 320, the UE 115-b may compute a feedback message associated with the one or more transmissions. For example, the UE 115-b may generate a second set of bits indicating whether the UE 115-b received the one or more transmissions based on the monitoring. In examples in which the UE 115-b did not receive one or more of the one or more transmission, the feedback information may indicate the one or more missed transmission.

The UE 115-b may compute, using the second set of bits, a first set of bits comprising a first CRC. In some examples, the UE 115-b may modify the first set of bits to obtain the CRC. For example, the UE 115-b may append a set of ones (e.g., 1's) to the first set of bits before inputting the second set of bits into a CRC computation function. Additionally, or alternatively, the UE 115-b may reverse an order of the second set of bits before inputting the first set of bits into the CRC computation function. Additionally, or alternatively, the UE 115-b may use a first CRC computation function (e.g., a polynomial or a CRC mask) associated with a size of the second set of bits (e.g., or a size of a HARQ feedback message including the second set of bits) to compute the CRC, where the first CRC computation function is different from a second CRC computation function associated with a second size of the second set of bits (e.g., or a second size of the HARQ feedback message).

At 325, the UE 115-b may encode the feedback message including the first set of bits and the second set of bits to generate a feedback message (e.g., a HARQ feedback message). In examples in which the UE 115-b reversed the second set of bits to generate the first set of bits, the UE 115-b may encode the reversed second set of bits and the second set of bits. The UE 115-b may encode the feedback message according to an encoding scheme (e.g., a polar encoding scheme).

At 330, the UE 115-b may transmit the HARQ feedback message to the network entity 105-b. In some examples, the UE 115-b may multiplex the HARQ feedback message with one or more UCI messages. In such examples, a third set of bits that are representative of the one or more UCI messages may be located sequentially after the second set of bits (e.g., the reversed second set of bits).

At 335, the network entity 105-b may decode the feedback message to generate the first set of bits and the second set of bits. For example, the network entity 105-b may decode the feedback message using a decoding scheme (e.g., a polar decoding scheme).

At 340, the network entity 105-b may determine the feedback information. In some examples, the network entity 105-b may generate a second CRC based on the decoded second set of bits. For example, the network entity 105-b may generate the second CRC based on the reversed second set of bits or based on appending a quantity of 1's to the second set of bits (e.g., in accordance with a CRC generation method used by the UE 115-b). Additionally, or alternatively, the network entity 105-b may generate the second CRC using the first CRC computation function associated with a size of the second set of bits (e.g., or a size of a HARQ feedback message including the second set of bits) to compute the CRC. For example, the network entity 105-b may use a CRC computation function associated with the HARQ feedback message size indicated via the control signaling.

In some examples, the network entity 105-b may determine that the first CRC is different from the second CRC based on comparing the first CRC and the second CRC. In such examples, the network entity 105-b may determine that the UE 115-b did not receive the control signaling indicating the HARQ feedback message size. In examples in which the network entity 105-b is configured with the first CRC computation function and the second CRC computation function, the network entity 105-b may generate a third CRC using the second CRC computation function, and may compare the first CRC with the third CRC. Additionally, or alternatively, in response to the first CRC being different from the second CRC, the network entity 105-b may determine that the UE 115-b did not receive the one or more transmissions.

In some examples, if the first CRC is the same as the second CRC (e.g., or the third CRC), the network entity 105-b may successfully determine the feedback information. The network entity 105-b may accordingly determine whether the UE 115-b received the one or more transmissions.

In examples in which the feedback information indicates that the UE 115-b did not receive one or more of the transmissions (e.g., or if the network entity 105-b does not determine the feedback information based on the first CRC being different from the second CRC), at 345, the network entity 105-b may retransmit some or all of the one or more transmissions. For example, the network entity 105-b may retransmit the one or more missed transmissions indicated by the feedback information or all of the one or more transmissions. The UE 115-b may accordingly receive the retransmissions.

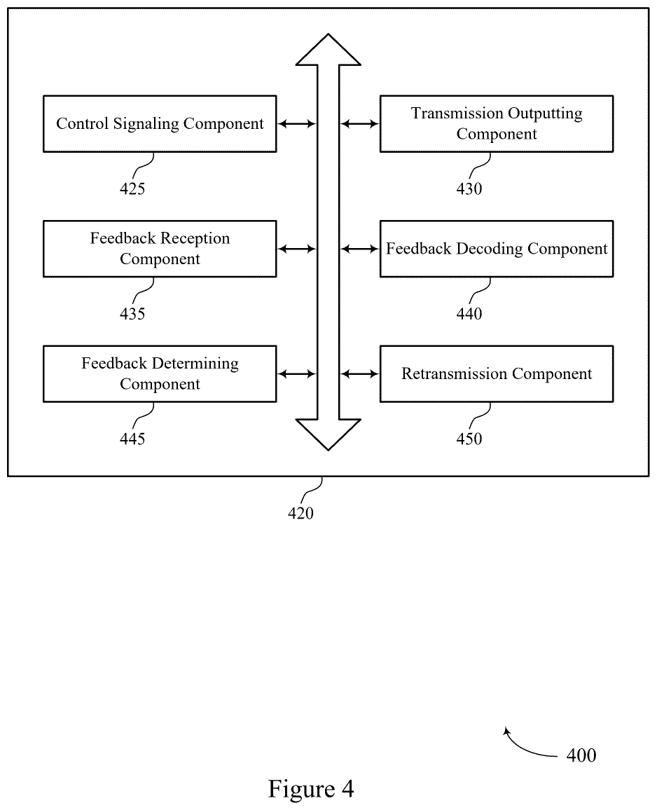

FIG. 4 shows an example of a processing system 420 that supports techniques for feedback message payload size correction. A processing system 420 may be an example of a processing system 145 (such as network entity 105) and may include a control signaling component 425, a transmission outputting component 430, a feedback reception component 435, a feedback decoding component 440, a feedback determining component 445, a retransmission component 450, or any combination thereof. A processing system 420, or various component thereof, may be an example of means for performing (such as a means for causing a network entity 105 to perform) various techniques described herein.

The control signaling component 425 may be configured to cause the network entity 105 to output a downlink control information message scheduling one or more transmissions. The transmission outputting component 430 may be configured to cause the network entity 105 to output the one or more transmissions. The feedback reception component 435 may be configured to cause the network entity 105 to obtain an HARQ feedback message. The feedback decoding component 440 may be configured to cause the network entity 105 to decode the HARQ feedback message according to a decoding scheme to obtain a first set of bits indicative of a first CRC and a second set of bits indicative of a payload, where the payload includes HARQ feedback information for the one or more transmissions. The feedback determining component 445 may be configured to cause the network entity 105 to determine the HARQ feedback information for the one or more transmissions in accordance with a comparison of the first CRC with a second CRC that is computed based on appending a quantity of ones to the second set of bits.

In some examples, to support determining the HARQ feedback information, the feedback determining component 445 may be configured to cause the network entity 105 to determine that a UE did not receive the one or more transmissions based on the first CRC being different from the second CRC. In some examples, to support determining the HARQ feedback information, the retransmission component 450 may be configured to cause the network entity 105 to output one or more retransmissions of the one or more transmissions.

In some examples, the control signaling component 425 may be configured to cause the network entity 105 to output first control signaling that indicates a first HARQ feedback message size. In some examples, the feedback determining component 445 may be configured to cause the network entity 105 to determine that a UE did not receive the first control signaling based on the first CRC being different from the second CRC.

In some examples, the feedback determining component 445 may be configured to cause the network entity 105 to determine the HARQ feedback information in accordance with the first CRC being the same as the second CRC.

In some examples, the HARQ feedback information indicates at least one missed transmission of the one or more transmissions, and the retransmission component 450 may be configured to cause the network entity 105 to output a retransmission of the at least one missed transmission of the one or more transmissions.

In some examples, the quantity of ones is greater than or equal to a length of the first CRC.

In some examples, the control signaling component 425 may be configured to cause the network entity 105 to output a downlink control information message scheduling one or more transmissions. In some examples, the transmission outputting component 430 may be configured to cause the network entity 105 to output the one or more transmissions. In some examples, the feedback reception component 435 may be configured to cause the network entity 105 to obtain an HARQ feedback message. In some examples, the feedback decoding component 440 may be configured to cause the network entity 105 to decode the HARQ feedback message according to an encoding scheme to obtain a first set of bits indicative of a first CRC and a second set of bits indicative of a payload, where the payload includes HARQ feedback information for the one or more transmissions. In some examples, the feedback determining component 445 may be configured to cause the network entity 105 to determine HARQ feedback information for the one or more transmissions based on a comparison of the first CRC and a second CRC determined from the payload and reversing an order of the second set of bits.

In some examples, the feedback determining component 445 may be configured to cause the network entity 105 to determine the HARQ feedback information in accordance with the first CRC being the same as the second CRC.

In some examples, the HARQ feedback information indicates at least one missed transmission of the one or more transmissions, and the feedback determining component 445 may be configured to cause the network entity 105 to determine that a UE did not receive the at least one missed transmission of the one or more transmissions based on the second set of bits including one or more zeros. In some examples, the HARQ feedback information indicates at least one missed transmission of the one or more transmissions, and the retransmission component 450 may be configured to cause the network entity 105 to output one or more retransmissions of the one or more transmissions.

In some examples, the one or more zeros include one or more frozen bits associated with the encoding scheme.

In some examples, the HARQ feedback message is multiplexed with one or more uplink control information messages. In some examples, a third set of bits indicative of the one or more uplink control information messages are located sequentially after the second set of bits.

In some examples, the control signaling component 425 may be configured to cause the network entity 105 to output a downlink control information message scheduling one or more transmissions. In some examples, the transmission outputting component 430 may be configured to cause the network entity 105 to output the one or more transmissions. In some examples, the feedback reception component 435 may be configured to cause the network entity 105 to obtain an HARQ feedback message including a first set of bits indicative of a first CRC and a second set of bits indicative of a payload, where the payload includes HARQ feedback information for the one or more transmissions. In some examples, the feedback decoding component 440 may be configured to cause the network entity 105 to compute a second CRC based on decoding the HARQ feedback message according to an encoding scheme and inputting the second set of bits into a first CRC computation function associated with a first size of the HARQ feedback message. In some examples, the feedback determining component 445 may be configured to cause the network entity 105 to determine HARQ feedback information for the one or more transmissions in accordance with a comparison of the first CRC and the second CRC.

In some examples, the feedback determining component 445 may be configured to cause the network entity 105 to compute a third CRC based on inputting the second set of bits into a second CRC computation function associated with a second size of the HARQ feedback message, where determining the HARQ feedback information includes determining that a UE did not receive a downlink control information message indicating a size of the HARQ feedback message in accordance with the third CRC being different from the first CRC, where computing the second CRC is based on the third CRC being different from the first CRC.

In some examples, determining the HARQ feedback information includes determining that a UE received a downlink control information message indicating a size of the HARQ feedback message in accordance with the second CRC being the same as the first CRC.

In some examples, the feedback determining component 445 may be configured to cause the network entity 105 to select the first CRC computation function in accordance with a modulo operation associated with an expected HARQ feedback message size.

In some examples, the first CRC computation function includes a cyclic redundancy check mask associated with the first set of bits.

In some examples, the first CRC computation function includes a cyclic redundancy check polynomial associated with the first set of bits.

A processing system 420 may include or be an example of one or more chips, SoCs, chipsets, packages, components, or devices that individually or collectively constitute or include a processing system. A processing system 420 may interface with other components of a network entity 105. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a network entity 105). Operations described herein with reference to the processing system 420, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 420 for operation in a processing system 420 as described herein, the processing system 420 may support techniques for CRC computation that may enable more efficient utilization of communication resources.

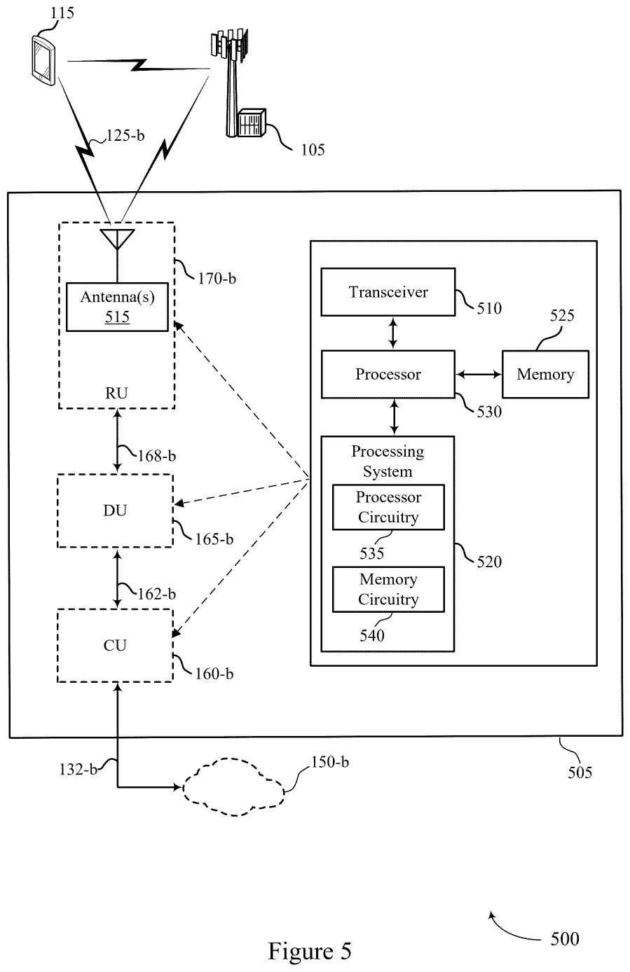

FIG. 5 shows an example of a system 500 including a device 505 that supports techniques for feedback message payload size correction. The device 505 may communicate (such as via one or more wired interfaces or one or more wireless interfaces) with other network devices or network equipment such as a core network 150-b, other network entities 105, UEs 115, or any combination thereof. The device 505 may include components for transmitting and receiving communication, which may include a processing system 520, a transceiver 510, antenna(s) 515, a memory 525, and a processor 530. Components of the device 505 may be coupled (such as operatively, communicatively, functionally, electronically, electrically, in electronic communication) via one or more interfaces.

The transceiver 510 may communicate bi-directionally with another transceiver via wired or wireless links, and may support transmission operations, reception operations, or both, as described herein. The transceiver 510 may include a modem to modulate and demodulate signals, to provide the modulated signals for transmission (such as via antenna(s) 515, via a wired interface), and to demodulate received signals (such as received via antenna(s) 515, received via a wired interface). The transceiver 510 may be operable to support communication via one or more communication links (such as a communication link 125-b, a backhaul link 132-b, a midhaul link 162-b, fronthaul link 168-b).

The processor 530 may be a general-purpose processing component that supports various operations (such as applications) of the device 505. The memory 525 may be a general-purpose storage component that stores code executable by the processor 530. Such code may include instructions that, when executed by the processor 530, cause the device 505 to perform various functions (such as to support an application of the device 505).

For examples in which the device 505 is a network entity 105 in a disaggregated architecture, one or more components of the device 505 may be located at one or more of a CU 160-b, a DU 165-b, or an RU 170-b, one or more of which may include aspects of the processing system 520, the processor 530, the memory 525, or the transceiver 510. Functions of the device 505 may be performed at different components or an operation may be divided between different components (such as different functions being supported by aspects of the CU 160-b, the DU 165-b, or the RU 170-b, the transceiver 510, the processor 530, the memory 525, the processing system 520, or any combination thereof). For example, the processing system 520 may be a component of one or more of the CU 160-b, the DU 165-b, or the RU 170-b. In some examples, interfaces between components of device 505 (such as CU 160-b, DU 165-b, RU 170-b) may support communication at a protocol layer or between protocol layers of a protocol stack.

In some examples, the processing system 520 may manage aspects of communication with the core network 150-b (such as via a backhaul link 132). For example, the processing system 520 may manage the transfer of data communication for UEs 115 with a gateway of the core network 150-b. In some examples, the processing system 520 may manage communication with one or more other network entities 105 and may include a controller or scheduler for controlling communication with UEs 115 (such as in cooperation with the one or more other network entities 105). In some examples, the processing system 520 may support an interface (such as X2 interface, Xn interface) to provide communication between network entities 105.

The processing system 520 may be an example of a processing system 145 or a processing system 400. For example, the processing system 520 may include processor circuitry 535 and memory circuitry 540 that stores code, and the processing system 520 may be configured to cause the device 505 to perform operations that support techniques for feedback message payload size correction. Although the processing system 520 is illustrated as a separate component, which may involve a separate chip, chipset, or other module, in some implementations, one or more functions described with reference to the processing system 520 may be supported by or performed by a transceiver 510, antenna(s) 515, a processor 530, memory 525, or any combination thereof, such that a processing system 520 may include one or more of a transceiver 510, antenna(s) 515, a processor 530, memory 525, or any combination thereof. Further, processor circuitry 535 and memory circuitry 540 each may be implemented at the device 505 in accordance with an aggregated architecture, or the processor circuitry 535 and the memory circuitry 540 may be implemented at one or more of a CU 160-b, a DU 165-b, or an RU 170-b in accordance with a disaggregated architecture.

By including or configuring the processing system 520 for operation in the device 505 as described herein, may support techniques for CRC computation that may enable improved communication reliability, reduced latency, and improved coordination between devices.

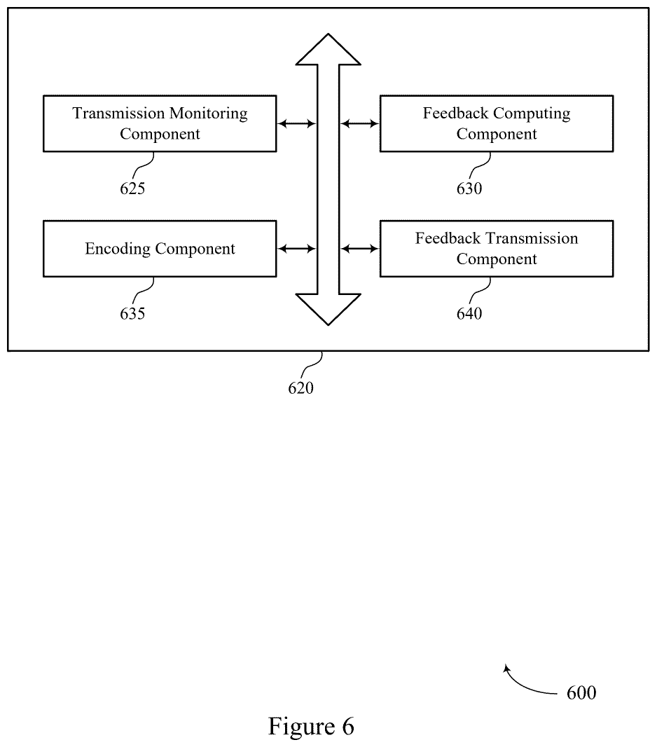

FIG. 6 shows an example of a processing system 620 that supports techniques for feedback message payload size correction. A processing system 620 may be an example of a processing system 140 (such as of a UE 115) and may include a transmission monitoring component 625, a feedback computing component 630, an encoding component 635, a feedback transmission component 640, or any combination thereof. A processing system 620, or various component thereof, may be an example of means for performing (such as a means for causing a UE 115 to perform) various techniques described herein.

The transmission monitoring component 625 may be configured to cause the UE 115 to monitor for one or more transmissions from a network entity. The feedback computing component 630 may be configured to cause the UE 115 to compute a first set of bits indicative of a first CRC based on appending a quantity of ones to a second set of bits indicative of a payload, where the payload includes HARQ feedback information for the one or more transmissions. The encoding component 635 may be configured to cause the UE 115 to encode the second set of bits according to an encoding scheme. The feedback transmission component 640 may be configured to cause the UE 115 to transmit the first set of bits and the encoded second set of bits.

In some examples, the encoding scheme includes a polar coding scheme.

In some examples, the HARQ feedback information indicates at least one missed transmission of the one or more transmissions.

In some examples, the transmission monitoring component 625 may be configured to cause the UE 115 to receive a retransmission of the at least one missed transmission in accordance with the HARQ feedback information.

In some examples, the quantity of ones is greater than or equal to a length of the first CRC.

In some examples, the transmission monitoring component 625 may be configured to cause the UE 115 to monitor for one or more transmissions. In some examples, the feedback computing component 630 may be configured to cause the UE 115 to compute a first set of bits indicative of a first CRC based on reversing an order of a second set of bits indicative of a payload, where the payload includes HARQ feedback information for the one or more transmissions from a network entity. In some examples, the encoding component 635 may be configured to cause the UE 115 to encode a HARQ feedback message including the first set of bits and the reversed second set of bits according to an encoding scheme. In some examples, the feedback transmission component 640 may be configured to cause the UE 115 to transmit the HARQ feedback message.

In some examples, the HARQ feedback information indicates at least one missed transmission of the one or more transmissions.

In some examples, the transmission monitoring component 625 may be configured to cause the UE 115 to receive a retransmission of the at least one missed transmission in accordance with the HARQ feedback information.

In some examples, the HARQ feedback message is multiplexed with one or more uplink control information messages. In some examples, a third set of bits indicative of the one or more uplink control information messages are located sequentially after the reversed second set of bits.

In some examples, the transmission monitoring component 625 may be configured to cause the UE 115 to monitor for one or more transmissions from a network entity. In some examples, the feedback computing component 630 may be configured to cause the UE 115 to compute a first set of bits indicative of a first CRC based at least in part on inputting a second set of bits indicative of a payload into a first CRC computation function associated with a size of an HARQ feedback message, where the payload includes HARQ feedback information for the one or more transmissions. In some examples, the encoding component 635 may be configured to cause the UE 115 to encode the HARQ feedback message according to an encoding scheme. In some examples, the feedback transmission component 640 may be configured to cause the UE 115 to transmit the HARQ feedback message including the first set of bits and the second set of bits.

In some examples, the feedback computing component 630 may be configured to cause the UE 115 to select the first CRC computation function in accordance with a modulo operation associated with a configured HARQ feedback message size.

In some examples, the first CRC computation function includes a cyclic redundancy check mask associated with a size of the first set of bits.

In some examples, the first CRC computation function includes a cyclic redundancy check polynomial associated with a size of the first set of bits.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for CRC computation that may enable more efficient utilization of communication resources.

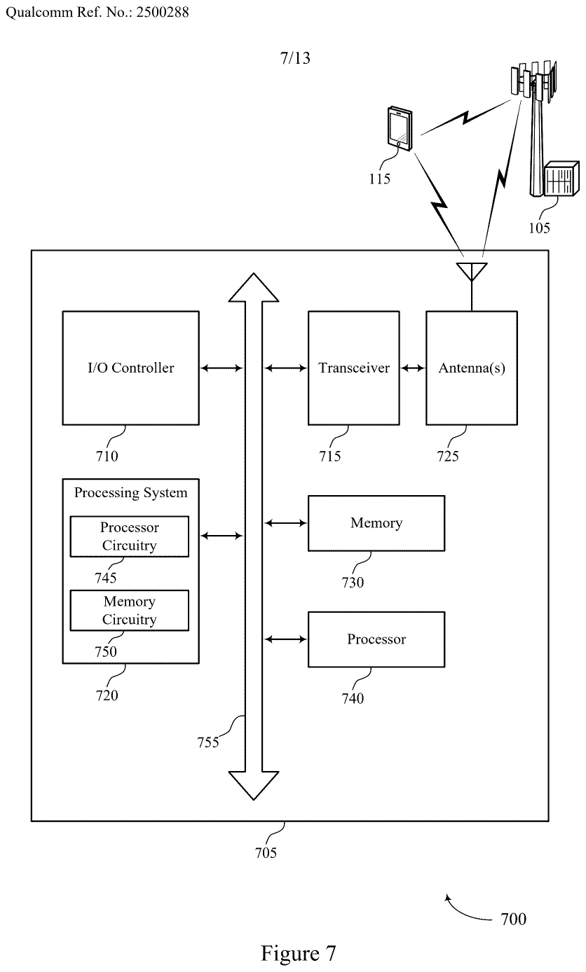

FIG. 7 shows an example of a system 700 including a device 705 that supports techniques for feedback message payload size correction. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 600. For example, the processing system 720 may include processor circuitry 745 and memory circuitry 750 that stores code, and may be configured to cause the device 705 to perform operations that support techniques for feedback message payload size correction. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for CRC computation that may enable for CRC computation that may enable improved communication reliability, reduced latency, and improved coordination between devices.

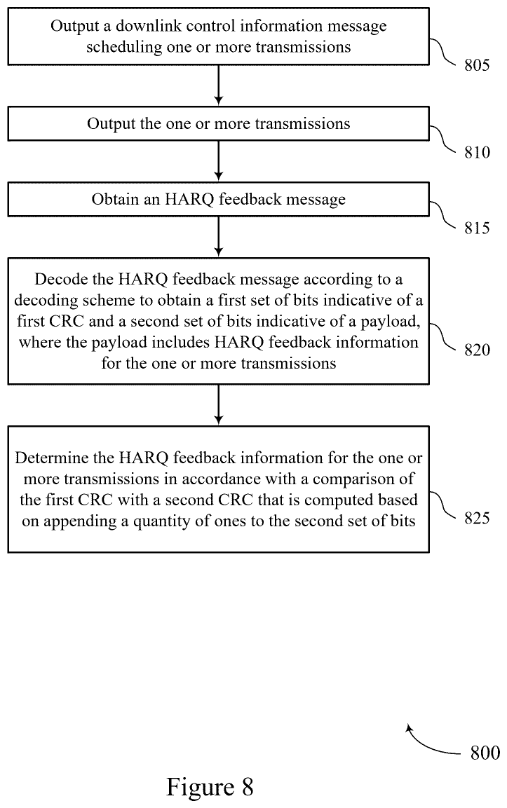

FIG. 8 shows an example of a method 800 that supports techniques for feedback message payload size correction. Operations of the method 800 may be performed by a network entity 105 or its components (such as using a processing system configured to cause the network entity to perform one or more operations) as described herein.

At 805, the method may include outputting a downlink control information message scheduling one or more transmissions. In some examples, aspects of the operations of 805 may be performed by a control signaling component 425.

At 810, the method may include outputting the one or more transmissions. In some examples, aspects of the operations of 810 may be performed by a transmission outputting component 430.

At 815, the method may include obtaining an HARQ feedback message. In some examples, aspects of the operations of 815 may be performed by a feedback reception component 435.

At 820, the method may include decoding the HARQ feedback message according to a decoding scheme to obtain a first set of bits indicative of a first CRC and a second set of bits indicative of a payload, where the payload includes HARQ feedback information for the one or more transmissions. In some examples, aspects of the operations of 820 may be performed by a feedback decoding component 440.

At 825, the method may include determining the HARQ feedback information for the one or more transmissions in accordance with a comparison of the first CRC with a second CRC that is computed based on appending a quantity of ones to the second set of bits. In some examples, aspects of the operations of 825 may be performed by a feedback determining component 445.

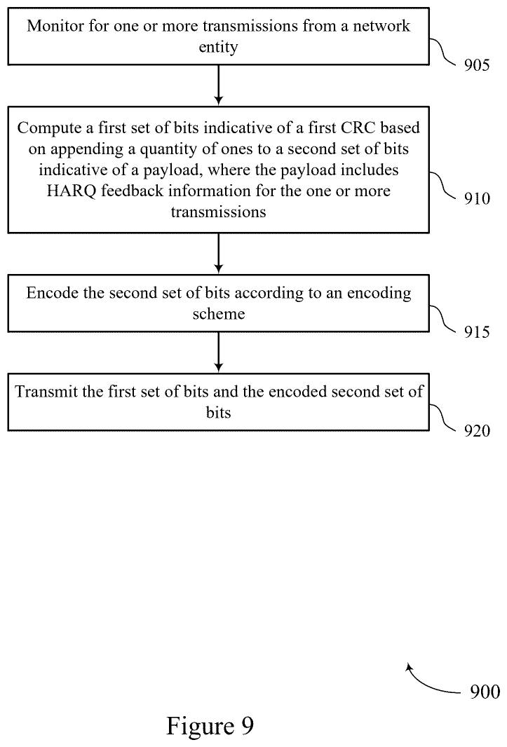

FIG. 9 shows an example of a method 900 that supports techniques for feedback message payload size correction. Operations of the method 900 may be performed by a UE or its components (such as using a processing system configured to cause the UE 115 to perform one or more of the operations) as described herein.

At 905, the method may include monitoring for one or more transmissions from a network entity. In some examples, aspects of the operations of 905 may be performed by a transmission monitoring component 625.

At 910, the method may include computing a first set of bits indicative of a first CRC based on appending a quantity of ones to a second set of bits indicative of a payload, where the payload includes HARQ feedback information for the one or more transmissions. In some examples, aspects of the operations of 910 may be performed by a feedback computing component 630.

At 915, the method may include encoding the second set of bits according to an encoding scheme. In some examples, aspects of the operations of 915 may be performed by an encoding component 635.

At 920, the method may include transmitting the first set of bits and the encoded second set of bits. In some examples, aspects of the operations of 920 may be performed by a feedback transmission component 640.

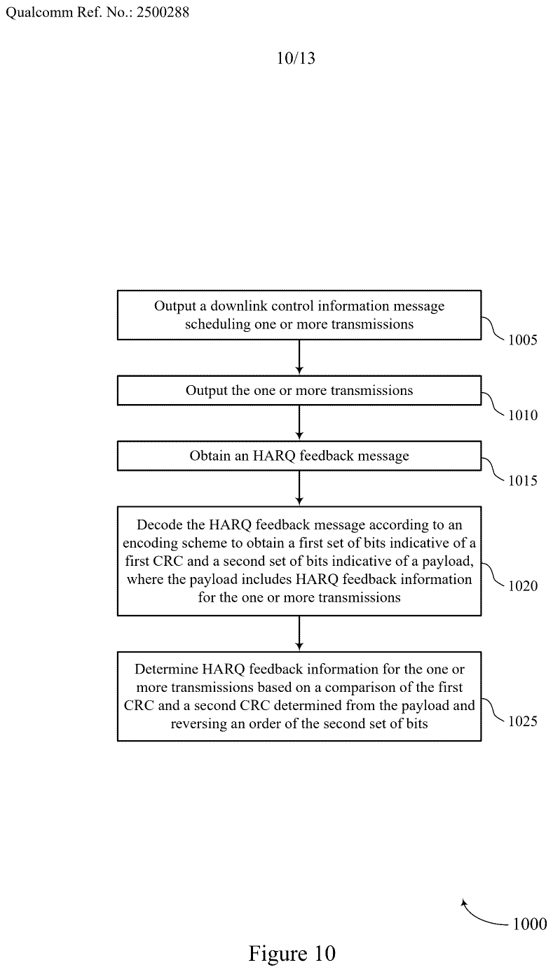

FIG. 10 shows an example of a method 1000 that supports techniques for feedback message payload size correction. Operations of the method 1000 may be performed by a network entity 105 or its components (such as using a processing system configured to cause the network entity to perform one or more operations) as described herein.

At 1005, the method may include outputting a downlink control information message scheduling one or more transmissions. In some examples, aspects of the operations of 1005 may be performed by a control signaling component 425.

At 1010, the method may include outputting the one or more transmissions. In some examples, aspects of the operations of 1010 may be performed by a transmission outputting component 430.

At 1015, the method may include obtaining an HARQ feedback message. In some examples, aspects of the operations of 1015 may be performed by a feedback reception component 435.

At 1020, the method may include decoding the HARQ feedback message according to an encoding scheme to obtain a first set of bits indicative of a first CRC and a second set of bits indicative of a payload, where the payload includes HARQ feedback information for the one or more transmissions. In some examples, aspects of the operations of 1020 may be performed by a feedback decoding component 440.

At 1025, the method may include determining HARQ feedback information for the one or more transmissions based on a comparison of the first CRC and a second CRC determined from the payload and reversing an order of the second set of bits. In some examples, aspects of the operations of 1025 may be performed by a feedback determining component 445.

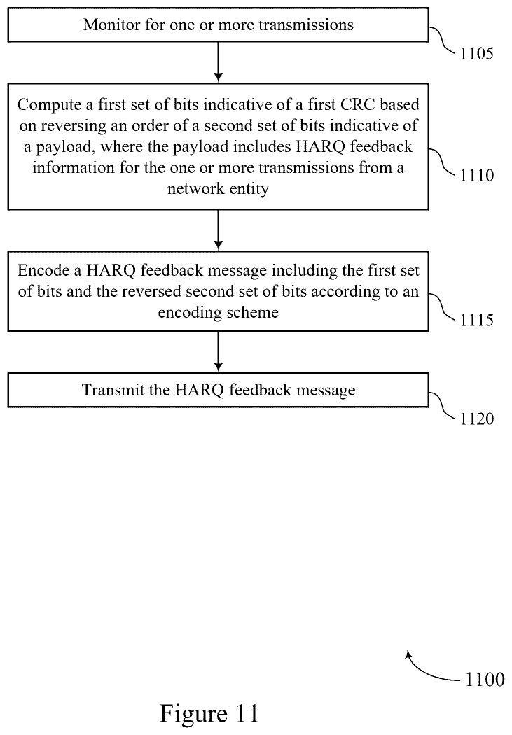

FIG. 11 shows an example of a method 1100 that supports techniques for feedback message payload size correction. Operations of the method 1100 may be performed by a UE or its components (such as using a processing system configured to cause the UE 115 to perform one or more of the operations) as described herein.

At 1105, the method may include monitoring for one or more transmissions. In some examples, aspects of the operations of 1105 may be performed by a transmission monitoring component 625.

At 1110, the method may include computing a first set of bits indicative of a first CRC based on reversing an order of a second set of bits indicative of a payload, where the payload includes HARQ feedback information for the one or more transmissions from a network entity. In some examples, aspects of the operations of 1110 may be performed by a feedback computing component 630.

At 1115, the method may include encoding a HARQ feedback message including the first set of bits and the reversed second set of bits according to an encoding scheme. In some examples, aspects of the operations of 1115 may be performed by an encoding component 635.

At 1120, the method may include transmitting the HARQ feedback message. In some examples, aspects of the operations of 1120 may be performed by a feedback transmission component 640.

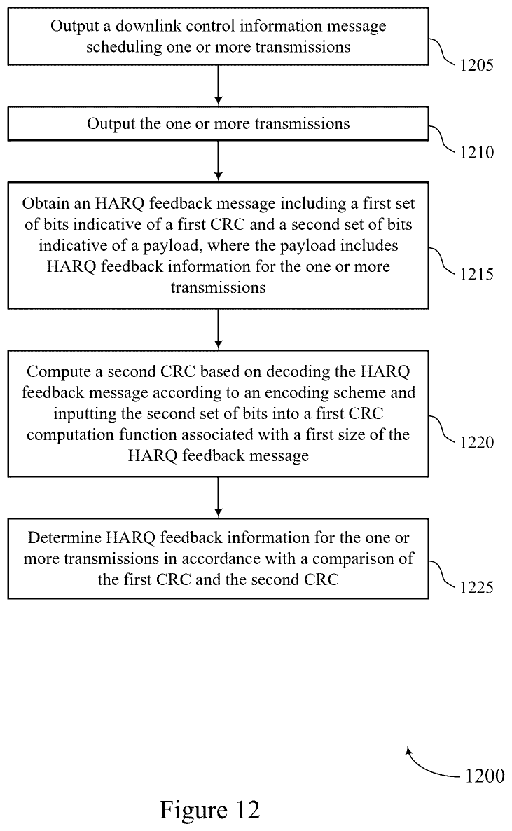

FIG. 12 shows an example of a method 1200 that supports techniques for feedback message payload size correction. Operations of the method 1200 may be performed by a network entity 105 or its components (such as using a processing system configured to cause the network entity to perform one or more operations) as described herein.

At 1205, the method may include outputting a downlink control information message scheduling one or more transmissions. In some examples, aspects of the operations of 1205 may be performed by a control signaling component 425.

At 1210, the method may include outputting the one or more transmissions. In some examples, aspects of the operations of 1210 may be performed by a transmission outputting component 430.

At 1215, the method may include obtaining an HARQ feedback message including a first set of bits indicative of a first CRC and a second set of bits indicative of a payload, where the payload includes HARQ feedback information for the one or more transmissions. In some examples, aspects of the operations of 1215 may be performed by a feedback reception component 435.

At 1220, the method may include computing a second CRC based on decoding the HARQ feedback message according to an encoding scheme and inputting the second set of bits into a first CRC computation function associated with a first size of the HARQ feedback message. In some examples, aspects of the operations of 1220 may be performed by a feedback decoding component 440.

At 1225, the method may include determining HARQ feedback information for the one or more transmissions in accordance with a comparison of the first CRC and the second CRC. In some examples, aspects of the operations of 1225 may be performed by a feedback determining component 445.

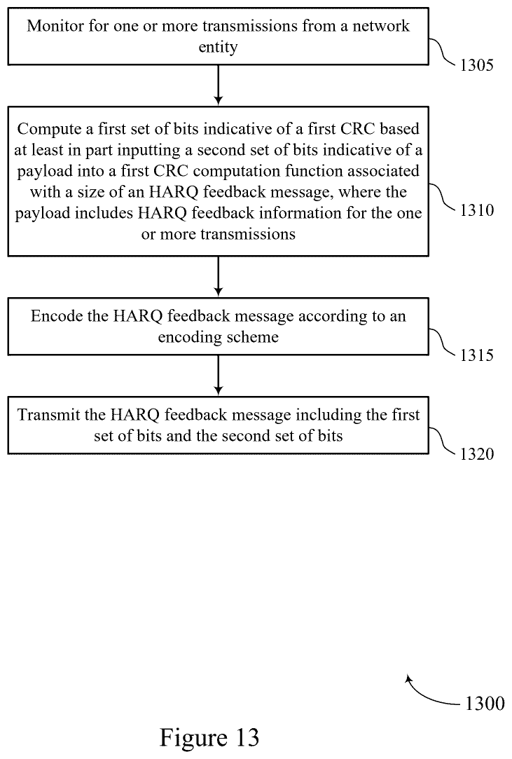

FIG. 13 shows an example of a method 1300 that supports techniques for feedback message payload size correction. Operations of the method 1300 may be performed by a UE or its components (such as using a processing system configured to cause the UE 115 to perform one or more of the operations) as described herein.

At 1305, the method may include monitoring for one or more transmissions from a network entity. In some examples, aspects of the operations of 1305 may be performed by a transmission monitoring component 625.

At 1310, the method may include computing a first set of bits indicative of a first CRC based at least in part on inputting a second set of bits indicative of a payload into a first CRC computation function associated with a size of an HARQ feedback message, where the payload includes HARQ feedback information for the one or more transmissions. In some examples, aspects of the operations of 1310 may be performed by a feedback computing component 630.

At 1315, the method may include encoding the HARQ feedback message according to an encoding scheme. In some examples, aspects of the operations of 1315 may be performed by an encoding component 635.

At 1320, the method may include transmitting the HARQ feedback message including the first set of bits and the second set of bits. In some examples, aspects of the operations of 1320 may be performed by a feedback transmission component 640.
Aspect 1: A method for wireless communications at a network entity, comprising: outputting a downlink control information message scheduling one or more transmissions; outputting the one or more transmissions; obtaining an HARQ feedback message; decoding the HARQ feedback message according to a decoding scheme to obtain a first set of bits indicative of a first CRC and a second set of bits indicative of a payload, wherein the payload comprises HARQ feedback information for the one or more transmissions; and determining the HARQ feedback information for the one or more transmissions in accordance with a comparison of the first CRC with a second CRC that is computed based at least in part on appending a quantity of ones to the second set of bits.
Aspect 2: The method of aspect 1, wherein determining the HARQ feedback information comprises: determining that a UE did not receive the one or more transmissions based at least in part on the first CRC being different from the second CRC; and outputting one or more retransmissions of the one or more transmissions.
Aspect 3: The method of any of aspects 1 through 2, further comprising: outputting first control signaling that indicates a first HARQ feedback message size; and determining that a UE did not receive the first control signaling based at least in part on the first CRC being different from the second CRC.
Aspect 4: The method of any of aspects 1 through 3, further comprising: determining the HARQ feedback information in accordance with the first CRC being the same as the second CRC.
Aspect 5: The method of aspect 4, wherein the HARQ feedback information indicates at least one missed transmission of the one or more transmissions, the method further comprising: outputting a retransmission of the at least one missed transmission of the one or more transmissions.
Aspect 6: The method of any of aspects 1 through 5, wherein the quantity of ones is greater than or equal to a length of the first CRC.
Aspect 7: A method for wireless communications at a UE, comprising: monitoring for one or more transmissions from a network entity; computing a first set of bits indicative of a first CRC based at least in part on appending a quantity of ones to a second set of bits indicative of a payload, wherein the payload comprises HARQ feedback information for the one or more transmissions; encoding the second set of bits according to an encoding scheme; and transmitting the first set of bits and the encoded second set of bits.
Aspect 8: The method of aspect 7, wherein the encoding scheme comprises a polar coding scheme.
Aspect 9: The method of any of aspects 7 through 8, wherein the HARQ feedback information indicates at least one missed transmission of the one or more transmissions.
Aspect 10: The method of aspect 9, further comprising: receiving a retransmission of the at least one missed transmission in accordance with the HARQ feedback information.
Aspect 11: The method of any of aspects 7 through 10, wherein the quantity of ones is greater than or equal to a length of the first CRC.
Aspect 12: A method for wireless communications at a network entity, comprising: outputting a downlink control information message scheduling one or more transmissions; outputting the one or more transmissions; obtaining an HARQ feedback message; decoding the HARQ feedback message according to an encoding scheme to obtain a first set of bits indicative of a first CRC and a second set of bits indicative of a payload, wherein the payload comprises HARQ feedback information for the one or more transmissions; and determining HARQ feedback information for the one or more transmissions based at least in part on a comparison of the first CRC and a second CRC determined from the payload and reversing an order of the second set of bits.
Aspect 13: The method of aspect 12, further comprising: determining the HARQ feedback information in accordance with the first CRC being the same as the second CRC.
Aspect 14: The method of aspect 13, wherein the HARQ feedback information indicates at least one missed transmission of the one or more transmissions, the method further comprising: determining that a UE did not receive the at least one missed transmission of the one or more transmissions based at least in part on the second set of bits comprising one or more zeros; and outputting one or more retransmissions of the one or more transmissions.
Aspect 15: The method of aspect 14, wherein the one or more zeros comprise one or more frozen bits associated with the encoding scheme.
Aspect 16: The method of claim 12, wherein the HARQ feedback message is multiplexed with one or more uplink control information messages, a third set of bits indicative of the one or more uplink control information messages are located sequentially after the second set of bits.
Aspect 17: A method for wireless communications at a UE, comprising: monitoring for one or more transmissions; computing a first set of bits indicative of a first CRC based at least in part on reversing an order of a second set of bits indicative of a payload, wherein the payload comprises HARQ feedback information for the one or more transmissions from a network entity; encoding a HARQ feedback message comprising the first set of bits and the reversed second set of bits according to an encoding scheme; and transmitting the HARQ feedback message.
Aspect 18: The method of claim 17, wherein the HARQ feedback information indicates at least one missed transmission of the one or more transmissions.
Aspect 19: The method of aspect 18, further comprising: receiving a retransmission of the at least one missed transmission in accordance with the HARQ feedback information.
Aspect 20: The method of claim 17, wherein the HARQ feedback message is multiplexed with one or more uplink control information messages, a third set of bits indicative of the one or more uplink control information messages are located sequentially after the reversed second set of bits.
Aspect 21: A method for wireless communications at a network entity, comprising: outputting a downlink control information message scheduling one or more transmissions; outputting the one or more transmissions; obtaining an HARQ feedback message comprising a first set of bits indicative of a first CRC and a second set of bits indicative of a payload, wherein the payload comprises HARQ feedback information for the one or more transmissions; computing a second CRC based at least in part on decoding the HARQ feedback message according to an encoding scheme and inputting the second set of bits into a first CRC computation function associated with a first size of the HARQ feedback message; and determining HARQ feedback information for the one or more transmissions in accordance with a comparison of the first CRC and the second CRC.
Aspect 22: The method of aspect 21, further comprising: computing a third CRC based at least in part on inputting the second set of bits into a second CRC computation function associated with a second size of the HARQ feedback message, wherein determining the HARQ feedback information comprises determining that a UE did not receive a downlink control information message indicating a size of the HARQ feedback message in accordance with the third CRC being different from the first CRC, wherein computing the second CRC is based at least in part on the third CRC being different from the first CRC.
Aspect 23: The method of claim 21, wherein determining the HARQ feedback information comprises determining that a UE received a downlink control information message indicating a size of the HARQ feedback message in accordance with the second CRC being the same as the first CRC.
Aspect 24: The method of claim 21, further comprising: selecting the first CRC computation function in accordance with a modulo operation associated with an expected HARQ feedback message size.
Aspect 25: The method of claim 21, wherein the first CRC computation function comprises a cyclic redundancy check mask associated with the first set of bits.
Aspect 26: The method of claim 21, wherein the first CRC computation function comprises a cyclic redundancy check polynomial associated with the first set of bits.
Aspect 27: A method for wireless communications at a UE, comprising: monitoring for one or more transmissions from a network entity; computing a first set of bits indicative of a first CRC based at least in part on inputting a second set of bits indicative of a payload into a first CRC computation function associated with a size of an HARQ feedback message, wherein the payload comprises HARQ feedback information for the one or more transmissions; encoding the HARQ feedback message according to an encoding scheme; and transmitting the HARQ feedback message comprising the first set of bits and the second set of bits.
Aspect 28: The method of claim 27, further comprising: selecting the first CRC computation function in accordance with a modulo operation associated with a configured HARQ feedback message size.
Aspect 29: The method of claim 27, wherein the first CRC computation function comprises a cyclic redundancy check mask associated with a size of the first set of bits.
Aspect 30: The method of claim 27, wherein the first CRC computation function comprises a cyclic redundancy check polynomial associated with a size of the first set of bits.
Aspect 31: A network entity for wireless communications, comprising a processing system that includes processor circuitry and memory circuitry that stores code, the processing system configured to cause the network entity to perform a method of any of aspects 1 through 6.
Aspect 32: A network entity for wireless communications, comprising at least one means for performing a method of any of aspects 1 through 6.
Aspect 33: A non-transitory computer-readable medium storing code for wireless communications, the code comprising instructions executable by one or more processors to perform a method of any of aspects 1 through 6.
Aspect 34: A UE for wireless communications, comprising a processing system that includes processor circuitry and memory circuitry that stores code, the processing system configured to cause the UE to perform a method of any of aspects 7 through 11.
Aspect 35: A UE for wireless communications, comprising at least one means for performing a method of any of aspects 7 through 11.
Aspect 36: A non-transitory computer-readable medium storing code for wireless communications, the code comprising instructions executable by one or more processors to perform a method of any of aspects 7 through 11.
Aspect 37: A network entity for wireless communications, comprising a processing system that includes processor circuitry and memory circuitry that stores code, the processing system configured to cause the network entity to perform a method of any of aspects 12 through 16.
Aspect 38: A network entity for wireless communications, comprising at least one means for performing a method of any of aspects 12 through 16.
Aspect 39: A non-transitory computer-readable medium storing code for wireless communications, the code comprising instructions executable by one or more processors to perform a method of any of aspects 12 through 16.
Aspect 40: A UE for wireless communications, comprising a processing system that includes processor circuitry and memory circuitry that stores code, the processing system configured to cause the UE to perform a method of any of aspects 17 through 20.
Aspect 41: A UE for wireless communications, comprising at least one means for performing a method of any of aspects 17 through 20.
Aspect 42: A non-transitory computer-readable medium storing code for wireless communications, the code comprising instructions executable by one or more processors to perform a method of any of aspects 17 through 20.
Aspect 43: A network entity for wireless communications, comprising a processing system that includes processor circuitry and memory circuitry that stores code, the processing system configured to cause the network entity to perform a method of any of aspects 21 through 26.
Aspect 44: A network entity for wireless communications, comprising at least one means for performing a method of any of aspects 21 through 26.
Aspect 45: A non-transitory computer-readable medium storing code for wireless communications, the code comprising instructions executable by one or more processors to perform a method of any of aspects 21 through 26.
Aspect 46: A UE for wireless communications, comprising a processing system that includes processor circuitry and memory circuitry that stores code, the processing system configured to cause the UE to perform a method of any of aspects 27 through 30.
Aspect 47: A UE for wireless communications, comprising at least one means for performing a method of any of aspects 27 through 30.
Aspect 48: A non-transitory computer-readable medium storing code for wireless communications, the code comprising instructions executable by one or more processors to perform a method of any of aspects 27 through 30.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
a processing system that includes processor circuitry and memory circuitry that stores code, the processing system configured to cause the network entity to:
output a downlink control information message scheduling one or more transmissions;
output the one or more transmissions;
obtain a hybrid automatic repeat request (HARQ) feedback message;
decode the HARQ feedback message according to a decoding scheme to obtain a first set of bits indicative of a first cyclic redundancy check (CRC) and a second set of bits indicative of a payload, wherein the payload comprises HARQ feedback information for the one or more transmissions; and
determine the HARQ feedback information for the one or more transmissions in accordance with a comparison of the first CRC with a second CRC that is computed based at least in part on appending a quantity of ones to the second set of bits.

2. The network entity of claim 1, wherein, to determine the HARQ feedback information, the processing system is configured to cause the network entity to:
determine that a user equipment (UE) did not receive the one or more transmissions based at least in part on the first CRC being different from the second CRC; and
output one or more retransmissions of the one or more transmissions.

3. The network entity of claim 1, wherein the processing system is further configured to cause the network entity to:
output first control signaling that indicates a first HARQ feedback message size; and
determine that a user equipment (UE) did not receive the first control signaling based at least in part on the first CRC being different from the second CRC.

4. The network entity of claim 1, wherein the processing system is further configured to cause the network entity to:
determine the HARQ feedback information in accordance with the first CRC being the same as the second CRC.

5. The network entity of claim 4, wherein the HARQ feedback information indicates at least one missed transmission of the one or more transmissions, and the processing system is further configured to cause the network entity to:
output a retransmission of the at least one missed transmission of the one or more transmissions.

6. The network entity of claim 1, wherein the quantity of ones is greater than or equal to a length of the first CRC.

7. A user equipment (UE), comprising:
a processing system that includes processor circuitry and memory circuitry that stores code, the processing system configured to cause the UE to:
monitor for one or more transmissions from a network entity;
compute a first set of bits indicative of a first cyclic redundancy check (CRC) based at least in part on appending a quantity of ones to a second set of bits indicative of a payload, wherein the payload comprises hybrid automatic repeat request (HARQ) feedback information for the one or more transmissions;
encode the second set of bits according to an encoding scheme; and
transmit the first set of bits and the encoded second set of bits.

8. The UE of claim 7, wherein the encoding scheme comprises a polar coding scheme.

9. The UE of claim 7, wherein the HARQ feedback information indicates at least one missed transmission of the one or more transmissions.

10. The UE of claim 9, wherein the processing system is further configured to cause the UE to:
receive a retransmission of the at least one missed transmission in accordance with the HARQ feedback information.

11. The UE of claim 7, wherein the quantity of ones is greater than or equal to a length of the first CRC.

12. A user equipment (UE), comprising:
a processing system that includes processor circuitry and memory circuitry that stores code, the processing system configured to cause the UE to:
monitor for one or more transmissions;
compute a first set of bits indicative of a first cyclic redundancy check (CRC) based at least in part on reversing an order of a second set of bits indicative of a payload, wherein the payload comprises hybrid automatic repeat request (HARQ) feedback information for the one or more transmissions from a network entity;
encode a HARQ feedback message comprising the first set of bits and the reversed second set of bits according to an encoding scheme; and
transmit the HARQ feedback message.

13. The UE of claim 12, wherein the HARQ feedback information indicates at least one missed transmission of the one or more transmissions.

14. The UE of claim 13, wherein the processing system is further configured to cause the UE to:
receive a retransmission of the at least one missed transmission in accordance with the HARQ feedback information.

15. The UE of claim 12, wherein:
the HARQ feedback message is multiplexed with one or more uplink control information messages, and
a third set of bits indicative of the one or more uplink control information messages are located sequentially after the reversed second set of bits.

16. A user equipment (UE), comprising:
a processing system that includes processor circuitry and memory circuitry that stores code, the processing system configured to cause the UE to:
monitor for one or more transmissions from a network entity;
compute a first set of bits indicative of a first cyclic redundancy check (CRC) based at least in part on inputting a second set of bits indicative of a payload into a first CRC computation function associated with a size of a hybrid automatic repeat request (HARQ) feedback message, wherein the payload comprises HARQ feedback information for the one or more transmissions;
encode the HARQ feedback message according to an encoding scheme; and
transmit the HARQ feedback message comprising the first set of bits and the second set of bits.

17. The UE of claim 16, wherein the processing system is further configured to cause the UE to:
select the first CRC computation function in accordance with a modulo operation associated with a configured HARQ feedback message size.

18. The UE of claim 16, wherein the first CRC computation function comprises a cyclic redundancy check mask associated with a size of the first set of bits.

19. The UE of claim 16, wherein the first CRC computation function comprises a cyclic redundancy check polynomial associated with a size of the first set of bits.
